(19) United States
(12) Patent Application Publication
(10) Pub. No.: US 2020/0034443 A1
(43) Pub. Date: Jan. 30, 2020

(54) Infrastructure Program Management Platform

(71) Applicant: HEWLETT PACKARD ENTERPRISE DEVELOPMENT LP, Houston, TX (US)

(72) Inventors: Brian Joseph Kentley, Dallas, TX (US); Stuti Singh, Dallas, TX (US)

(21) Appl. No.: 16/046,480

(22) Filed: Jul. 26, 2018

(51) Int. Cl. G06F 17/30; G06Q 10/06; G06Q 10/08; H04L 29/06

(52) U.S. Cl. CPC G06F 17/3056; G06F 17/30595; H04L 63/101; G06Q 10/08; G06Q 10/06313

(57) ABSTRACT

An infrastructure program management system and methodology includes a master data repository containing tables of data relating to assets associated with a program, including infrastructure assets, application assets, facilities assets, human assets, etc. The master data repository is maintained in a relational database, such that various dependencies between assets are identified. Dependencies between assets and release and requirements metrics specified for an infrastructure program are also identified in the data repository.

### BACKGROUND

The management of an infrastructure program, i.e, the information technology (IT) resources of an enterprise, involves initiating, planning, executing, controlling, and completing the work necessary to achieve specific goals and meet specific requirement criteria at a specified time. An infrastructure program may be a temporary or ongoing endeavor designed to achieve one or more desired objectives with respect to the IT resources involved. An infrastructure program may consist of one or more infrastructure projects, and each such project may consist of one or more tasks.

At least one, and often many infrastructure assets are typically associated with an infrastructure program, project, or task. Infrastructure assets (“assets”) include the IT and computing resources associated with the program, project, or task.

### BRIEF DESCRIPTION OF THE DRAWINGS

For a detailed description of various examples, reference will now be made to the accompanying drawings, in which:

FIG. 1 is a block diagram of an infrastructure program management system in accordance with one example;

FIG. 2 is a block diagram showing interrelated elements of a master data repository maintained in the infrastructure program management system of FIG. 1;

FIG. 3 is a block diagram showing the logical architecture of the master data repository of FIG. 2;

FIG. 4 is a flow diagram depicting a methodology for operation of an infrastructure program management system;

FIGS. 5a, 5b, 5c, and 5d are example graphical dashboard presentations of data by an infrastructure program management system;

FIG. 6 is a block diagram representing a computing device implementing an infrastructure program management system, according to one or more disclosed examples;

FIG. 7 represents a computer network infrastructure that may be used to implement all or part of an infrastructure program management system according to one or more disclosed examples; and

FIG. 8 illustrates a computer processing device that may be used to implement the functions, modules, processing platforms, execution platforms, communication devices, and other methods and processes of this disclosure.

### DETAILED DESCRIPTION

In this description, for purposes of explanation, numerous specific details are set forth in order to provide a thorough understanding of the examples disclosed herein. It will be apparent, however, to one skilled in the art that the disclosed example implementations may be practiced without these specific details. In other instances, structure and devices are shown in block diagram form in order to avoid obscuring the disclosed examples. Moreover, the language used in this disclosure has been principally selected for readability and instructional purposes and may not have been selected to delineate or circumscribe the inventive subject matter, resorting to the claims being necessary to determine such inventive subject matter. Reference in the specification to “one example” or to “an example” means that a particular feature, structure, or characteristic described in connection with the examples is included in at least one implementation.

The term “information technology” (IT) refers herein broadly to the field of computers of all types, computing systems, and computing resources, the software executed, by computers, as well the mechanisms, physical and logical by which such technology may be deployed for users.

The terms “computing system” and “computing resource” are generally taken to refer to at least one electronic computing device that includes, but is not limited to, a single computer, virtual machine, virtual container, host, server, laptop, and/or mobile device, or to a plurality of electronic computing devices working together to perform the function(s) described as being performed on or by the computing system. The term also may be used to refer to a number of such electronic computing devices in electronic communication with one another.

The term “cloud,” as in “cloud computing” or “cloud resource,” refers to a paradigm that enables ubiquitous access to shared pools of configurable computing resources and higher-level services that can be rapidly provisioned with minimal management effort; often, cloud resources are accessed via the Internet. An advantage of cloud computing and cloud resources is that a group of networked computing resources providing services need not be individually addressed or managed by users; instead, an entire provider-managed combination or suite of hardware and software can be thought of as an amorphous “cloud.”

The term “medium” refers to one or more non-transitory physical media that together store the contents described as being stored thereon. Examples may include non-volatile secondary storage, read-only memory (ROM), and/or random-access memory (RAM). Such media may be optical or magnetic.

The terms “application” and “function” refer to one or more computing modules, programs, processes, workloads, threads and/or a set of computing instructions executed by a computing system. Example implementations of applications and functions include software modules, software objects, software instances and/or other types of executable code. Note, the use of the term “application instance” when used in the context of cloud computing refers to an instance within the cloud infrastructure for executing applications (e.g., for a customer in that customer's isolated instance).

As noted, an infrastructure program may be a temporary or ongoing endeavor designed to achieve one or more desired objectives with respect to the IT resources involved, and may be time-constrained, and/or constrained by funding or staffing considerations. An infrastructure program may consist of one or more infrastructure projects, and each such project may consist of one or more tasks. Examples of infrastructure programs include the migration of a corporate entity's data center to a new location or to new hardware, the deployment of an operational software package or environment within a corporate environment, or application rationalization programs for optimizing a corporate entity's use and deployment of hardware and software resources.

An infrastructure program may comprise any number of discrete or otherwise separately identifiable infrastructure projects. In the case of a data center migration program, for example, one project among others would be the physical and logical migration of the data servers.

An infrastructure project, in turn, may comprise any number of discrete or otherwise identifiable tasks. Continuing with the data center migration example, a task associated with a data server migration project may be the physical and logical set-up of the data servers residing in the data center, and another may be establishing the network, connecting those data servers.

Infrastructure programs, projects, and tasks typically involve numerous assets. Assets associated with an infrastructure program, project, or task include, without limitation: the underlying infrastructure, that is, the IT and computing resources necessary for the program, such as computers, servers, networking equipment and connections, and so on; applications, that is, the software, software stacks, software bundles, operating systems and the like, necessary for the program; facilities, that is, the physical accommodation of the necessary assets; and human assets, that is the persons involved in any phase of the program from conception to implementation and end use.

Each asset associated with an infrastructure program will have one or more attributes that may be of relevance to the execution and management of the infrastructure program. For example, the relevant attributes of a program asset comprising a computer may include (without limitation) its make, model and other technical specifications, its operating system, its physical location, its network connections and connection capabilities, its, peripherals, the software it is utilized to execute, and so on. The relevant attributes of a program asset comprising application software may include (without limitation) its name, function, release version, licensing restrictions, lifecycle and so on.

Infrastructure programs may be subject to evaluation according to release and requirement metrics providing a continual or periodic gauge of a program's attainment of specified objectives, including functional objectives, scheduling/timing objectives, and so on.

A challenge in infrastructure program management is that there are usually many dependencies existing between the various assets associated with an infrastructure program or project. By dependency it is meant that a change in one asset or some one or more attributes of an asset may have an effect upon the operation of another one or more assets.

A simple example of an asset dependency is a situation in which a particular computer (computing resource) is utilized to perform multiple functions, perhaps executing two or more separate applications at any given time. A given asset such as a computer, for example, may serve both a storage function and a networking/connectivity function, or a storage function and an application execution function, within a given infrastructure. In such a case, the asset can be considered to have a dependency with one or more other assets within the infrastructure. Consequently, any malfunction, modification or adjustment of a particular asset may have an effect upon one or more other assets with which it has dependencies. If malfunctions, modifications, or adjustments are made to any asset without consideration of dependencies associated with the asset, the infrastructure as a whole can be adversely affected, to degrees ranging from minor to severe. Dependencies may also exist among and between computing assets and the specifications and requirements (testing, validation, costs, sustainability, etc.) of a program. Dependencies may also exist among and between applications and/or the associated interfaces. For example, a sales application may have a dependency on a separate and distinct payment processing application. This dependency may have additional requirements for operations such as latency or location. If this dependency malfunctions, modifications, or adjustments are made to any asset without consideration of dependencies associated with the asset, the infrastructure as a whole can be adversely affected, to degrees ranging from minor to severe.

Notably, dependencies may exist as well as among and between infrastructure assets and the release and requirement metrics, including risks-assumptions-issues-dependencies (RAID) logs, service level agreements (SLAs), and other specifications applicable to a given program. Such dependencies can create logistical constraints upon the execution of an infrastructure program.

With regard to RAID logs, risks include events that will have an adverse impact on a program if they occur. Assessment of risk involves consideration and evaluation of the likelihood that an event will occur, and the degree of impact on the program if it does occur. The higher the likelihood of an event, and the higher the degree of impact an event has on a program, the higher the risk assessment of that event. A RAID log includes identification and description of identified risks. A RAID log may also include data reflecting analyses and mitigation contingency plans for identified risks.

It would be an improvement to the technical art of infrastructure program management to provide systems and methods which include the obtaining or providing of detailed identification of assets and their relevant attributes, as well as mapping of the aforementioned dependencies, both among and between assets and among and between assets and the release and requirement parameters specified for an infrastructure programs or projects, in order to accurately and successfully complete the programs and projects without unavoidable adverse effects or failures to achieve one or more milestones or objectives established for the programs and projects.

Information regarding an infrastructure's assets and their unique attributes, to the extent that it may be documented at all, often resides in multiple sources, such as configuration management databases (CMDBs), shared spreadsheets, ad hoc databases, and the like, and in different organizations or departments of organizations. Even more undesirably, asset information may be partially or wholly undocumented within an organization and may only exist within the collective knowledge of a single person or a very limited group of people, and then, perhaps only partially.

Even when information regarding infrastructure assets and their respective attributes is readily available, changes over time are likely to occur. For example, a particular computer running one or more infrastructure-related applications may fail or otherwise be subject to replacement or relocation at an unforeseen and/or unplanned time. In situations where information concerning assets and their attributes is maintained in a shared spreadsheet, for example, there is significant opportunity for data inaccuracy issues, as the reliability and accuracy of the data may be dependent upon the diligence of one or more people in maintaining the content of a spreadsheet. Such issues raise the risks of infrastructure degradation or failure both to the organization, its infrastructure, and to any infrastructure program consultant entity.

Automated asset discovery tools may be available in some cases, but the effectiveness of such discovery tools is inherently limited by the types of information that is discoverable by automated processes, the degree to which such tools are regularly deployed, and manner in which discovered information is utilized. Maintaining asset information in spreadsheets is problematic because multiple resources may be updating the data, such that version control issues can arise, even if the spreadsheets are maintained on a shared file system or service. Moreover, consistent identification of assets and their attributes is often not supplied, and reporting becomes inaccurate, necessitating excessive human intervention and attention simply to address data consistency and accuracy.

Ad hoc database solutions, e.g., Microsoft Access™ databases, tend to focus on a simplified collection of assets and typically do not recognize or consider the potentially complex relationships and dependencies between assets, requirements, and projects. Also, data accuracy can be compromised for ad hoc database approaches where multiple users have access.

Existing CMDB tools can be very costly to implement. This makes CMDB tools impractical for some programs or projects. CMDB tools can be difficult and complex to deploy, as they are typically intended to be a broad-based resource for IT operations. Additionally, CMDB tools are not designed to incorporate or account for infrastructure program requirements or support other program management and project task functions.

Automated asset discovery tools are also often difficult and costly to implement. Implementing automated asset discovery tools can conflict with an organization's security concerns, and can be inconvenient and disruptive to daily operations of the organization. Automated asset discovery tools have a limited ability to discern asset dependencies, such as application-to-server dependencies, and often fail to shorten the timeline of a complex infrastructure program. Like CMDBs, automated asset discovery tools are not designed to incorporate or account for infrastructure program requirements or support other program management functions.

Thus, as noted above, it would be an improvement to the technical art of infrastructure program management as implemented on a computing platform that may or may not be cloud-based to provide a program management system and methodology capable of managing, tracking, analyzing, and reporting on the progression and logistics of infrastructure programs, in part through the mapping of and accounting for dependencies among assets associated with such infrastructure programs, as well as mapping the dependencies which exist between infrastructure assets and the release and requirement metrics specified for an infrastructure project.

A data center migration of an enterprise is one example of an infrastructure program. A data center migration involves the relocation of an enterprise's IT infrastructure, or some part thereof, from one location to another. Considerable logistical planning is required for such a program.

An early phase of a data center migration typically involves establishing a network infrastructure at the new location, in order for resources which are migrated to be utilized. Following this, in some cases a dedicated encrypted pipeline, such as a virtual private network (VPN) may be established between the new location and the starting location.

Migration may begin with the identification of some function (e.g., application) from the starting location to be moved to the new location. Analysis of the dependencies and impacts may be accomplished to identify applications with less critical functionality that may be selected to be migrated first. Initially, it may be desirable to provide some amount of computing resource hardware (e.g., computers) at the new location so that applications can initially be moved without physically moving the underlying hardware. Eventually, existing hardware from the starting location will be physically moved to the new location, as data center migrations preferably do not require complete replacement of underlying hardware assets. The physical relocation of hardware assets is one example of the logistical considerations involved in an infrastructure program.

Once a function/application to be moved has been identified, configuration management database (CMDB) tools and/or automatic asset discovery tools may be utilized to identify hardware assets having a dependency with the function/application. Then, it is necessary to identify other functions/applications which have dependencies with the same hardware assets. It is then possible to temporarily migrate such other functions/applications to other hardware assets at the starting location, such that the hardware assets associated with the function/application to be moved no longer have other dependencies.

The function/application can then be migrated to the new location, either by physical transportation of the associated hardware assets from the starting location to the new location or by providing enough hardware assets at the new location to allow for a more seamless transition. Whether or not a scheduled “outage” for the functionality is an option depends upon the nature of the function/application involved, and such issues are generally addressed in the release and requirements metrics specified for the infrastructure program.

Once operational at the new location, the relocated function/application can be reactivated due to the existence of the dedicated pipeline/VPN between the starting location and the new location. At this time, any temporary migration of the original function/application can be discontinued. The other functions/applications which were temporarily migrated to eliminate their dependencies with the migrated hardware may, if desired, be reconsolidated with the hardware resources at the new location. Alternatively, such other applications/functions may be subsequently migrated as part of discrete migration projects.

The migration process as just described can be repeated over and over again until all functionality/applications have been successfully migrated from the starting location to the new location. Often, the migration of the most critical functionality/applications of an enterprise will be conducted only after it is shown that the dedicated pipeline and other infrastructure issues are adequate to sustain operations with minimal or no interruption. Once migration is completed, the dedicated pipeline is no longer necessary and may be disabled.

As is apparent from the foregoing example scenario, there may be innumerable logistical considerations which arise in connection with an infrastructure program. Such logistical considerations involve not only the infrastructure assets themselves but also the release and requirement metrics applicable to an infrastructure program. As a simple example, an infrastructure program may include a requirement metric which specifies that a particular function/application cannot be disabled for even a short time. This may be the case, of course, for applications which are central to the operations of an enterprise. In such a case, decisions about how and which hardware assets are to be available to support such applications during a migration program must be made. Such decisions, in turn, may be influenced by other release and requirement metrics and constraints.

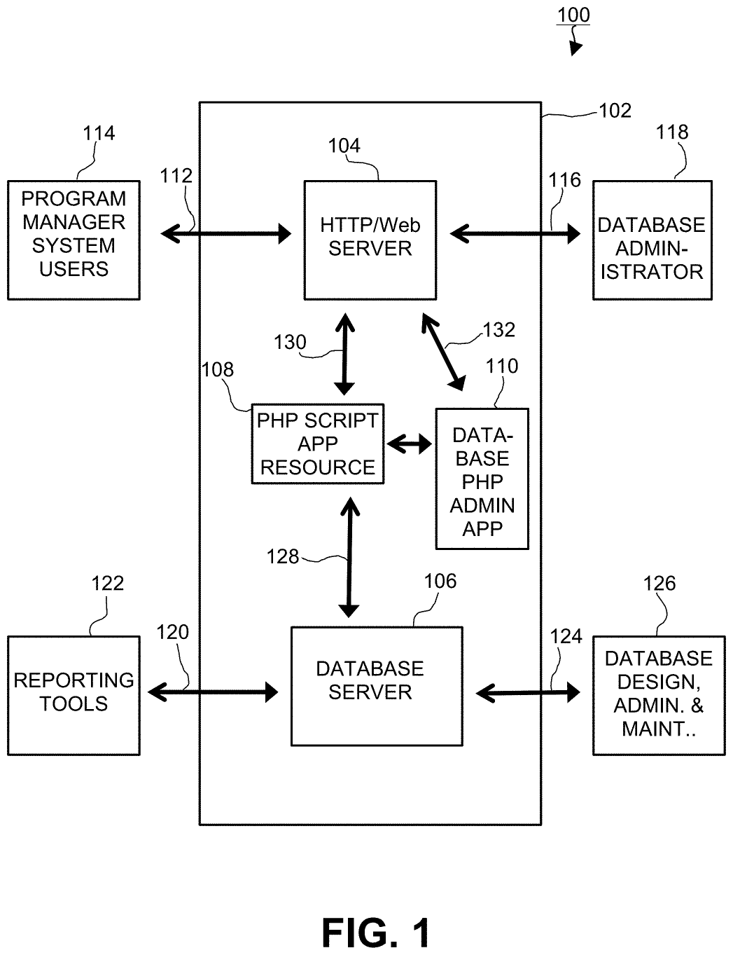

Referring to FIG. 1, there is shown a block diagram of the architecture of an example infrastructure program management system 100. As shown in FIG. 1, architecture 100 includes a platform 102 consisting of computing resource subsystems, including an HTTP/web server 104, a database server 106, and a PHP (hypertext preprocessor) script execution resource 108 having an associated a database PHP administrative application 110 for managing database server 106.

In the example of FIG. 1, platform 102 may be implemented using a LAMP model service stack. As is known, a LAMP service stack is a set of computing resources based on the Linux operating system. (“LAMP” is an acronym referring to its components, namely the Linux (or Gnu) operating system, the Apache HTTP server, the MySQL relational database management system, and the PHP programming/scripting language.)

Thus, in platform 102, operating under the Linux operating system, HTTP/web server 104 may be an implementation of the open-source cross-platform web server Apache HTTP, database server 106 may be an implementation of the open-source MySQL relational database management system (RDBMS). Physically, database server 106 may comprise a persistent memory storage device with sufficient storage capacity to accommodate the functionality described herein, such as a hard disk drive, an array of hard disk drives, an optical disk drive, or a solid state memory storage device. PHP administrative application 110 may be an implementation of the open-source PHPMyAdmin administration tool.

With continued reference to FIG. 1, platform 102 provides access via an HTTP port 112 provided and maintained by HTTP/web server 104 to users 114 of the infrastructure program management system of this example. Users 114 may include a program management consulting entity, or a client entity, for example. Platform also provides access via an HTTP port 116 between HTTP/web server 104 and a database administrator 118.

A transmission control protocol (TCP) port 120 provides an interface between database server 106 and one or more reporting tool resources 122. (TCP port 3306 is registered with the Internet Assigned Numbers Authority (IANA) for communication with MySQL database systems). Another TCP port 124 (e.g., another TCP 3306 port) is shown providing an interface between database server 106 and a database design, administration and maintenance application 126, such as MySQL Workbench.

Another TCP port 128 interfaces database server 106 with PHP server 108. PHP server 108 communicates PHP scripts with HTTP/web server 104 via a link 130. A link 132 is provided to allow communication between PHP administration application 110 and HTTP/web server 104.

In the current example, infrastructure program management system 100 is configured to maintain in database server 106 a master data repository including available information regarding the assets of an infrastructure program, and their attributes, as well as program and project management data elements, release dates and milestones, and requirement, acceptance, and service constraints, as well as risks-assumptions-issues-dependencies (RAID) logs. The incorporation of requirement and release data and the data linkages reflecting dependencies of this data with other assets enables system 100 to address and/or avoid logistical issues that may otherwise arise if such data were not taken into account.

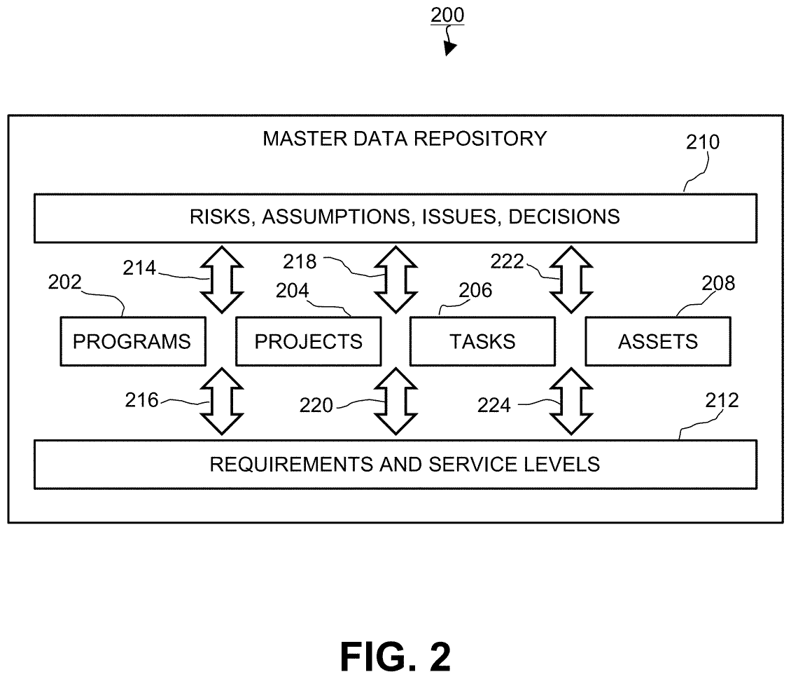

FIG. 2 illustrates generally the constituent elements of a master data repository 200 in one example. As shown in FIG. 2, master data repository 200 includes information about infrastructure programs 202, the projects 204 associated with the programs 202, the tasks 206 associated with the projects, and program assets 208. Master data repository 200 further contains data concerning risks, assumptions, issues, and dependencies associated the projects or programs (i.e., a RAID log) 210, as well as requirements and service level data 212. Arrows 214, 216, 218, 220, 222, and 224 in FIG. 2 are intended to reflect that in this example, master data repository 200 is a relational database structured and maintained in such a way as to take into account the interrelationships which exist among the stored data. Thus, for example, risks-assumptions-issues-dependencies (RAID) data 210 can relate to any of the programs data 202, projects data 204, tasks data 206, and/or assets data 208, as can requirements and services levels data 212.

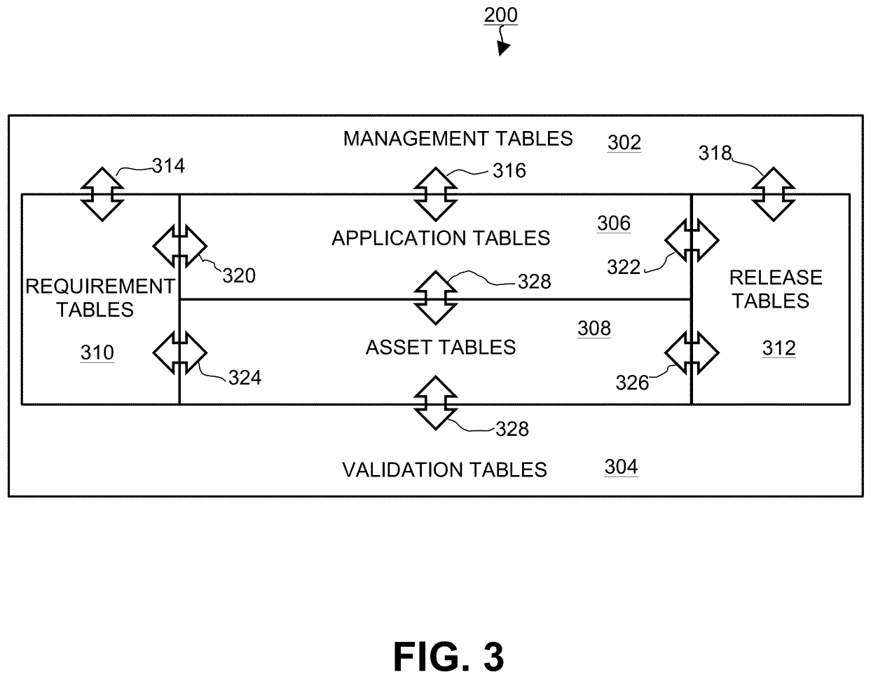

In the present example, master data repository 200 may be organized as a collection of data elements comprising tables of data. In this example, master data repository 200 comprises a complex relational database of information in the form of discrete data, configuration items, and/or tables of data and configuration items. FIG. 3 depicts the logical architecture of master data repository 200 in accordance with this example.

In the example of FIG. 3, there are shown a plurality of major table groupings and their associated linkages, corresponding to potential asset dependencies that are recognized by system 100. In FIG. 3, master data repository 200 is shown to comprise Management Tables 302, reflecting data associated with the management system itself, as well as Validation Tables 304 reflecting data useful for validation of operation of management system 100.

Further, FIG. 3 shows that master data repository 200 includes Application Tables 306, Asset Tables 308, Requirement Tables 310, and Release Tables 312.

Arrows 314, 316, 318, 320, 322. 324. 326, and 328 in FIG. 3 are intended to reflect and illustrate the various linkages or dependencies via certain data items' respective relationships with other data. Thus, for example, FIG. 3 shows that linkages or dependencies can exist between Application Tables 306 and both Asset Tables 308 and Management Tables 302; linkages or dependencies likewise exist between Requirement Tables 301 and both Application Tables 306 and Asset Tables 308, as well as with Management Tables 302 and Validation Tables 304. (As intended by the depiction in FIG. 3, Management Tables 302 and Validation Tables 304 are different and serve separate functions, but they both encompass the total architecture of master data repository 200.)

In the present example, infrastructure program management system 100 offers advantages over prior approaches. Through the creation and maintenance of the tables 302 . . . 312 in master data repository 200, system 100 is able to link the various aspects of a program's planning to requirements definitions and to physical assets. The linkages enable details of the actions, risk and impacts to be clearly articulated to stakeholders.

One feature of the example of FIG. 3 is the presence of links 314, 320, and 324, as well as links 318, 322, and 326. Links 314, 320, and 324 reflect the ability of system 100 to account for program requirements or goals as they affect or are affected by to other aspects of an infrastructure program, while links 318, 322, and 326 reflect the ability of system 100 to account for established release schedules and other logistical constraints or goals, as they affect or are affected by other aspects of an infrastructure program.

The linkages 314, 320, and 324, respectively, between Requirement Tables 310 and Management Tables 302, Application Tables 306, and Asset Tables 308, coupled with the linkages 318, 322, and 326, respectively, between Release Tables 312 and Management Tables 302, Application Tables 306, and Asset Tables 308, advantageously enhances the ability of system 100 to coordinate and account for the logistics of a program, including compliance with specified program requirements and specified release milestones. Moreover, these linkages are beneficial to the maintenance of a RAID log such as previously described.

A feature of the present example is that master data repository can be created and updated by providing system 100 with data from a plurality of disparate sources, including, without limitation, spreadsheets, CSV files, ad hoc databases, CMDB systems, automated discovery tools, and so on, as well as through manual user input of data records, such as by users 114 communicating through HTTP port 112 (FIG. 1) or database administrators communicating through HTTP port 116 and/or 124. Database server 106 is configured and operable in cooperation with other components of platform 102 as herein described to accept and incorporate data from disparate sources to create and maintain master data repository 200.

In the current example, infrastructure program management system 100 includes a PHP script application resource 108 which accesses the master data repository 200 maintained on database server 106. PHP script application resource 108 implements much interactive functionality of system 100 through execution of PHP scripts for accessing and processing data from data repository 200 and presenting data in various forms to users 114 via s/web server 104 and HTTP port 112.

In the present example, HTTP/web server 104 functions to provide a user interface to management platform 102, enabling users 114 to access platform 102. The content provided to users 114 is created through the functionality of PHP script execution resource 108 drawing upon the data from database server 106.

As noted, one function of infrastructure program management system 100 is to maintain a master data repository 200 of the assets associated with an infrastructure program, and their relevant attributes. The data of master data repository 200 may take the form of individual data items, referred to as “configuration items,” which themselves may include and/or be included within tables of other data items. The following is a general framework for specifying the types, organization, and relation of data to be maintained in master data repository 200 in accordance with one example:

Program and Project Management Data

This data corresponds generally to the management tables region 302 and validation tables region 304 in the logical architecture shown in FIG. 3. In this example, the Program and Project Management data consists of the following:

Program Configuration Items

This data enables multiple project reporting under a single program entity, i.e., parent-to-child relationships between Programs and Projects.

Project Configuration Items

This data establishes a relationship linkage and monitoring metric within a Program. Examples of a Project configuration items include: migration of a system to a cloud storage service; upgrade of an operating system; application regression testing.

RAID Log Items

The purpose of a risk-assumptions-issues-dependencies (RAID) log is to consolidate specified reporting and compliance elements for an infrastructure program, and to identify the effects of and relationships with other configuration items, such as Program Configuration items, Project Requirements, Release-related configuration items, Application configuration items, and Server configuration items.

Application Task Items

Application Task data may take the form of one or more data items or tables of data which relate Application-related tasks to a Project. Applications may have one or multiple tasks associated therewith. For example, first to relocate an application, then to decommission it from its old location. Application tasks establish a dependency relationship between Applications and Projects.

Server Task Items

Server Task data may take the form of one or more data items or tables of data which relate Server-related tasks to a Project. Servers may have one or multiple tasks associated therewith. For example, first to upgrade a Server, then to relocate the Server. Server tasks establish a dependency relationship between Servers and Projects.

Storage Task Items

Storage Task data may take the form of one or more data items or tables of data which link Storage assets to a Project. Storage assets may have one or multiple tasks associated therewith. For example, first to upgrade a Storage asset, then to relocate the Storage asset. Storage tasks establish a dependency relationship between Storage assets and Projects.

Network Task Items

Network Task data may take the form of one or more data items or tables of data which link Network assets to a Project. Network assets may have one or multiple tasks associated therewith. For example, first to upgrade a Network asset, then to relocate the Network asset. Network tasks establish a dependency relationship between Network assets and Projects.

Weekly Program Report Items

This data includes weekly Program reports.

Release and Requirements Data

This data corresponds generally to the requirement tables region 310 and release tables region 312 in the logical architecture shown in FIG. 3. In this example, the Release and Requirements data consists of the following:

Release Schedule Items

This data may take the form of one or more data items or tables of data and may include details for the release schedule including, for example, release numbers, release dates, and descriptions of capabilities of releases.

Release Milestone Items

This data provides milestone tracking associated with Release Schedule items. As such, this data establishes dependencies with the Programs and Project Management data described above.

Requirements Items

This data may comprise a collection of requirements (e.g., functional, non-functional, business, and so on) for application to a traceability metric, enabling verification that requirements have been addressed by the Program.

Service Level Agreement (SLA) Items

This data may comprise a collection of metrics defining deliverables during a Program. As is known, SLAs represent a commitment between a service provider and a client. Particular aspects of the service, such as quality, availability, responsibilities—are agreed between the service provider and the service user. SLA metrics are a means for tracking when an infrastructure program has advanced to points where given SLA terms have been met.

People and Places Data

This data corresponds generally to a portion of the assets tables region 308 in the logical architecture shown in FIG. 3. In this example, the People and Places data consists of the following:

Contact Configuration Items

This data may comprise a table containing contact information for persons and places and their relationship(s) with other configuration items.

Data Center Configuration Items

This data may take the form of one or more data items or tables of data and may include listings of data centers where Program-related infrastructures or services are located. This data facilitates validation for the data center information contained in other configuration items. Preferably, as Program assets are incorporated into the data, this data is updated to create appropriate mapping relationships with such assets.

Application and Environments Data

This data corresponds generally to the applications tables region 306 and validation tables region 304 in the logical architecture shown in FIG. 3. In this example, the Applications and Environments data consists of the following:

Application Configuration Items

This data may take the form of one or more data items or tables of data and may include listings of Program-related applications. Preferably, applications are identified with unique names and are mapped to the environments in the Environments Configuration Items data. This data allows a single application to have a one-to-one or one-to-many relationship with one or more Environments.

Environment Configuration Items

This data may take the form of one or more data items or tables of data and may include identification of computing environments with which an Application is associated. Environments may be related to Program Assets.

Questionnaire Configuration Items

Questionnaire data is used to facilitate data collection from stakeholders and may take the form of one or more data items or table of data used to link data collection required to the source being collected. For example, a questionnaire on application configuration attributes would link to the attributes of the Application Configuration Item.

Application Components Items

This data includes details of constituent application software components of the Program, such as identification of vendor, version, end-of-life/end-of-service information, and so on.

Assets Data

This data corresponds generally to the assets tables region 308 in the logical architecture shown in FIG. 3. In this example, the Assets data consists of the following:

Server Configuration Items

This data may take the form of one or more data items or tables of data and preferably includes relevant data concerning server assets and their associated attributes, contact information, and notes.

Storage Configuration Items

This data may take the form of one or more data items or tables of data and preferably includes relevant data concerning storage assets and their associated attributes, contact information, and notes.

Network Configuration Items

This data may take the form of one or more data items or tables of data and preferably includes relevant data concerning network assets and their associated attributes, contact information, and notes.

Database Configuration Items

This data may take the form of one or more data items or tables of data and preferably includes relevant data concerning the database software running on Servers, preferably including make and version information for such database software.

Mapping Data

This data corresponds generally to a subset of the management tables region 302 in the logical architecture shown in FIG. 3. In this example, the Mapping data consists of the following:

Server-to-Application Mapping

This data creates or identifies relationships between Environment configuration items (which in turn may be related to Application configuration items) and Server configuration items.

Server-to-Network Mapping

This data creates or identifies relationships between Server configuration items and Network configuration items.

Server-to-Storage Mapping

This data creates or identifies relationships between Server configuration items and Storage configuration items.

Network-Attached Storage (NAS) Configuration Items

This data creates or identifies relationships between Server configuration items and network-attached storage resources associated with the Program.

Storage Area Network (SAN) Configuration Items

This data creates or identifies relationships between Server configuration items and storage area network resources associated with the Program.

IP Address Items

This data may take the form of one or more data items or tables of data and preferably includes information creating relationships between Server Configuration Items and IP addresses.

Lookup Tables

This data preferably provides for data consistency by containing specific values used in a particular client environment.

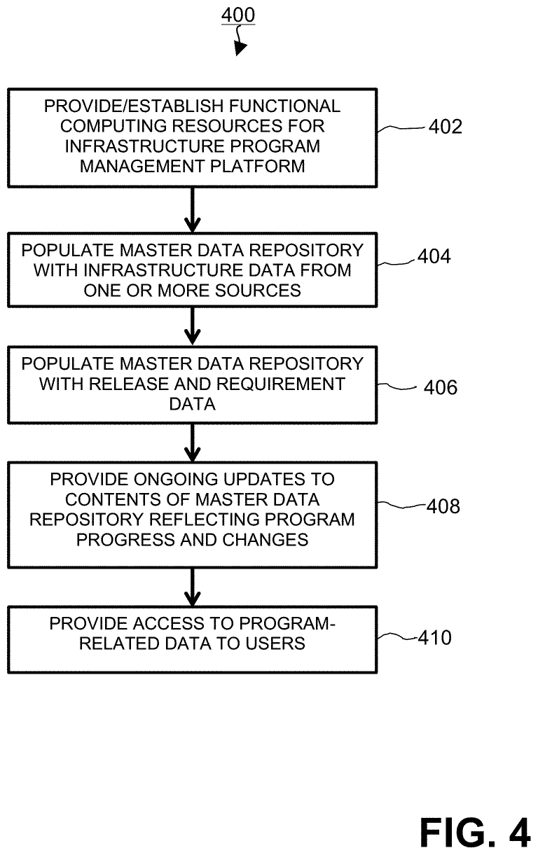

A methodology for implementing an infrastructure program management system platform such as platform 102 in the example of FIG. 1 is depicted in flowchart 400 of FIG. 4. (It is to be understood that certain steps depicted in flowchart 400 may or may not depend upon the prior commencement or completion of others, and that some steps may be performed in a different order than shown in FIG. 4, or may even be partially or fully performed concurrently with one another.)

A first step 402 in FIG. 4 is to provide and establish the underlying functional computing resources of a platform such as platform 102. This involves providing the necessary computational resources to implement a database server, such as database server 106 in FIG. 1, a PHP script execution resource such as resource 108 in FIG. 1, an HTTP/web server such as server 104 in FIG. 1, and so on, along with the infrastructure required to provide the various ports, such as ports 112, 116, 120, and 124 of platform 102 in FIG. 1. As noted, the computational resources comprising these functional constituents may be implements in various ways, including having one or more such resources implemented as cloud-based resources.

A next step 404 in the methodology of FIG. 4 is to populate a master data repository, such as master data repository 200 in FIG. 2, with infrastructure data. As noted, a platform such as platform 102 in FIG. 1 is preferably implemented with functionality which enables data to be provided to platform 102 (and incorporated into a master data repository such as master data repository 200) from a variety of sources, including without limitation spreadsheets of various types and formats, databases of various types and formats, configuration management database (CMDB) tools, such as are known in commercially available, and automated asset discovery tools, such as are also known and commercially available. Further, a platform such as platform 102 is preferably implemented to facilitate the manual entry of infrastructure data to be incorporated into a master data repository such as master data repository 200. In the example of FIG. 1, for instance, infrastructure data entry may be possible for users 114, database administrators 118, and/or database design, administrative and maintenance entities 126.

A next step 406 in the methodology of FIG. 4 is to populate a master data repository with release and requirement data in order to populate the release and requirement tables such as tables 310 and 312 in the example of FIG. 3. As noted with reference to FIG. 3, the release and requirement data is related to the infrastructure asset, application, management and validation data. This advantageously enables a platform such as platform 102 to address logistical issues and considerations in the management of an infrastructure program.

Referring again to FIG. 4, next step 408 in the methodology of FIG. 4 is to provide ongoing updates to data contained in a master data repository such as master data repository 200. Such updates preferably reflect progress made during the course of an infrastructure program, as well as other changes such as changes to infrastructure assets associated with the program. Updates to a master data repository may occur at different times depending upon the source(s) of the data. Automated asset discovery and CMDB tools may enable asset data, for example, to be updated on a real-time or near real-time basis, or at regular periodic intervals. Changes to release and requirement data populating a master data repository may be made less frequently, such as when changes are specified.

A next step 410 in the methodology depicted in FIG. 4 is to provide access to infrastructure program data to users, such as users 114 in FIG. 1. In the example of FIG. 1, such user access may be facilitated by reporting tool resources 122. For example, users, such as users 114 in the example of FIG. 1, may be presented with a “dashboard”-style graphical user interface (GUI) with which users may interact to view and analyze data according to individual interests and concerns. One example of a third-party reporting tool which may be suitable for the purposes of the present disclosure is the Qlik® Sense software commercially available from Qlik Technologies Inc., Radnor, Pa. (USA).

In one example, user access to infrastructure program data maintained in master data repository may be restricted to certain users, such as by maintaining an access control list. User access, and the type of user access (e.g., read only, read-write) as well as the types of data, may be restricted by maintaining such an access control list as part of the overall functionality of system 100.

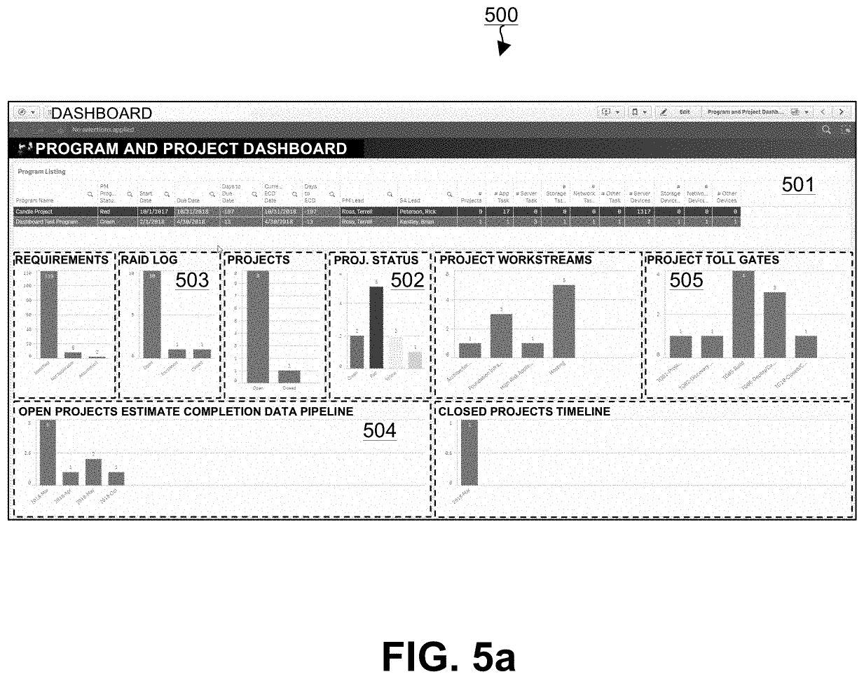

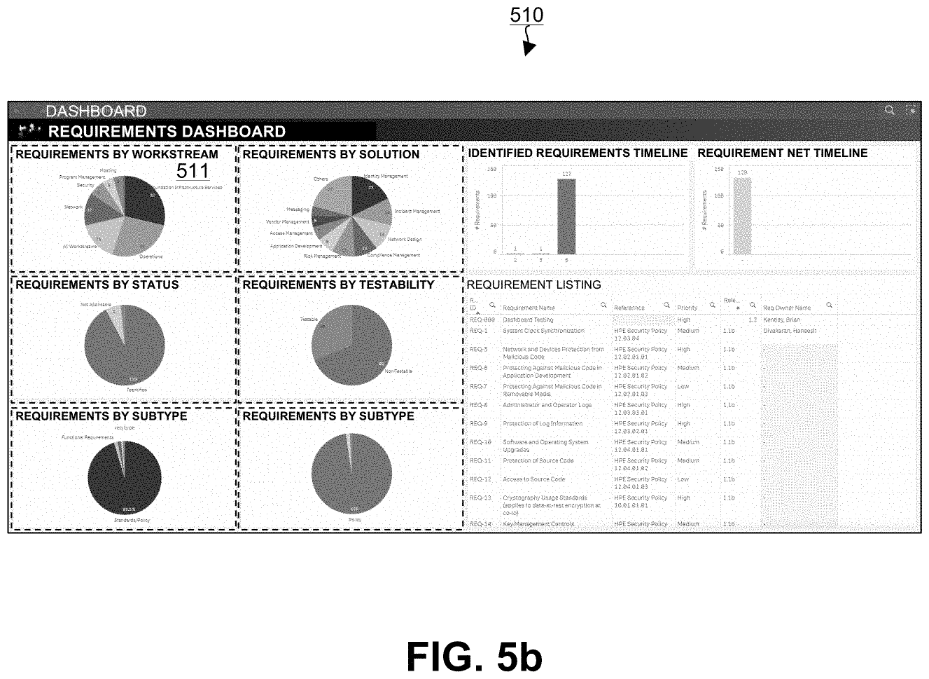

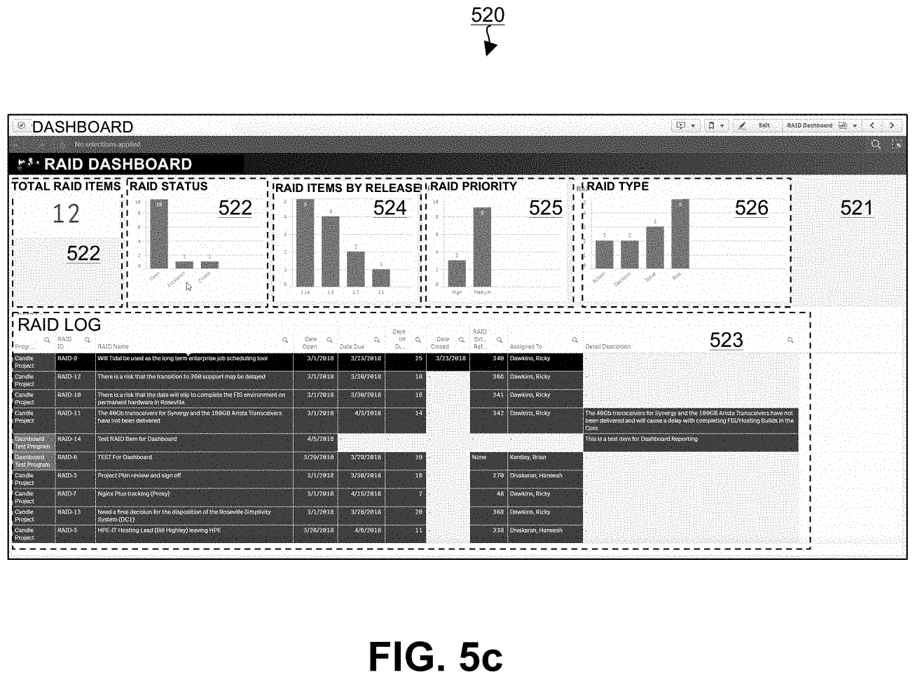

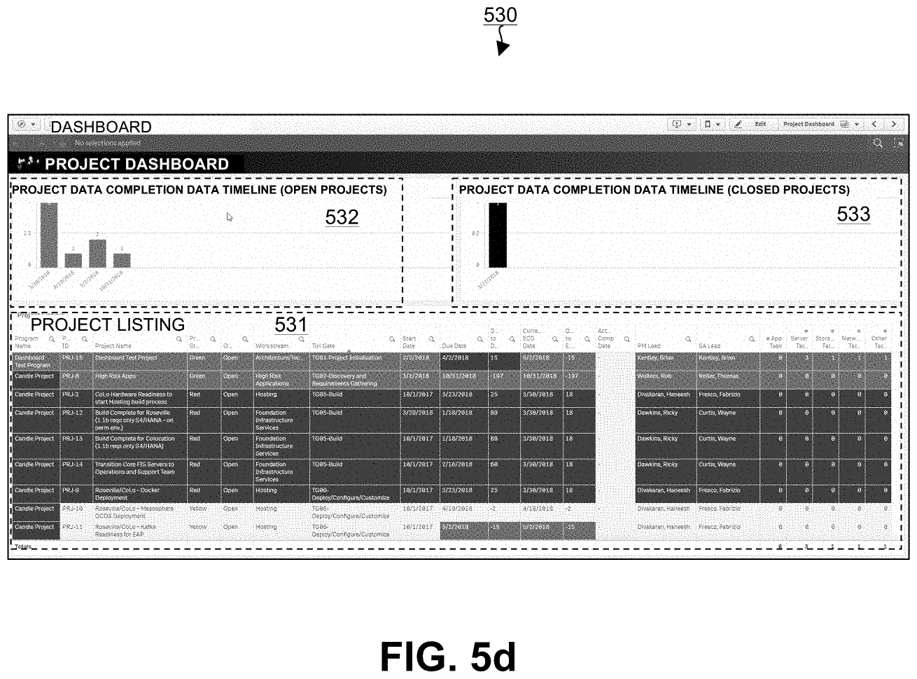

FIGS. 5a, 5b, 5c, and 5d are examples of “dashboard” style GUI presentations of data by a platform such as platform 102 from FIG. 1. In one implementation, GUI presentations of data by a platform such as platform 102 are interactive, enabling a user to select which data to be displayed and/or the manner in which it is displayed.

FIG. 5a, for example, depicts a program and projects dashboard GUI 500 which presents an overview of various program and project parameters and other status information, including, for example current Program Status, Key Performance Indicators (KPIs) such as open/escalated RAID items, pipeline reporting, toll gate status, impacted assets, and other KPIs necessary to articulate progress and barriers.

FIG. 5B depicts a requirements dashboard GUI 510 which presents such release and requirements-related information as requirements by workstream, traceability matrix (i.e. has a requirement been met), timeline impacts, types of requirements (i.e. functional/non-functional), and may include other KPIs necessary to articulate progress and barriers. FIG. 5c is a RAID dashboard GUI 520 which presents an overview of RAID-related aspects of a program, including such information as total RAID issues, number of issues open, escalated or closed, issues impacting releases, priority, and types of items. FIG. 5d depicts a project dashboard GUI 530 which presents project-related information such as project status and state reporting, project toll gate state, time to completion metrics, impacted assets. Additional metrics may include project and task gant charts and KPIs necessary to articulate progress and barriers.

In addition to dashboard GUIs such as described with reference to FIGS. 5a-5d, platform 102 may further be operable to generate various reports including summaries, graphs, and other compilations and representations of relevant data. Such reports may be generated on demand, such as by presenting reporting options to users 114 on a GUI. Such reports may also be generated periodically on some regular schedule, so as to provide a historical tracking of the progress of an infrastructure program.

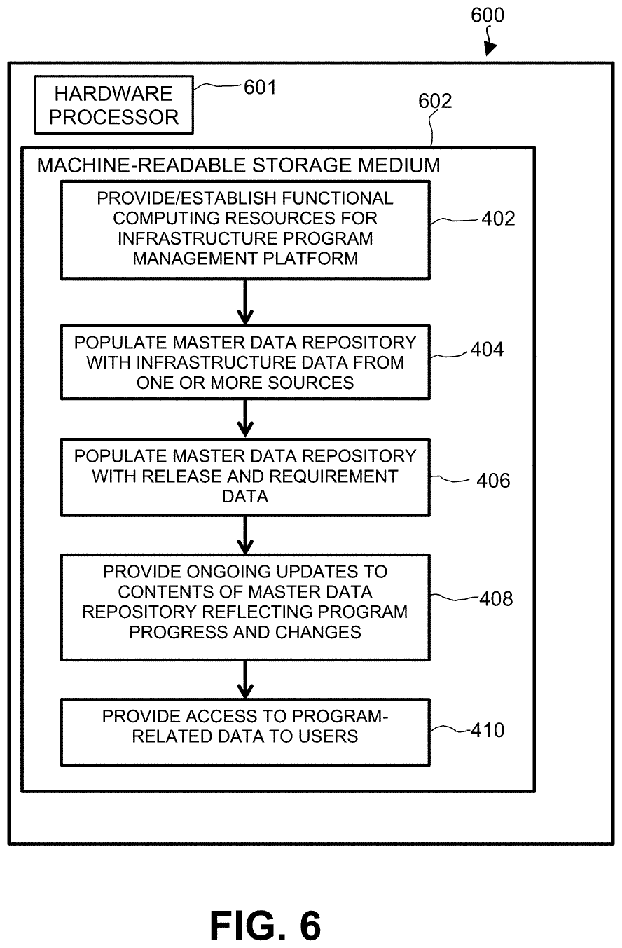

FIG. 6 is a block diagram representing a computing resource 600 implementing a method of infrastructure program management, according to one or more disclosed examples. Computing device 600 includes at least one hardware processor 601 and a machine readable storage medium 602. As illustrated, machine readable medium 602 may store instructions, that when executed by hardware processor 601 (either directly or via emulation/virtualization), cause hardware processor 601 to perform one or more disclosed methods to support infrastructure program management. In this example, the instructions stored reflect a methodology 400 as described with reference to FIG. 4.

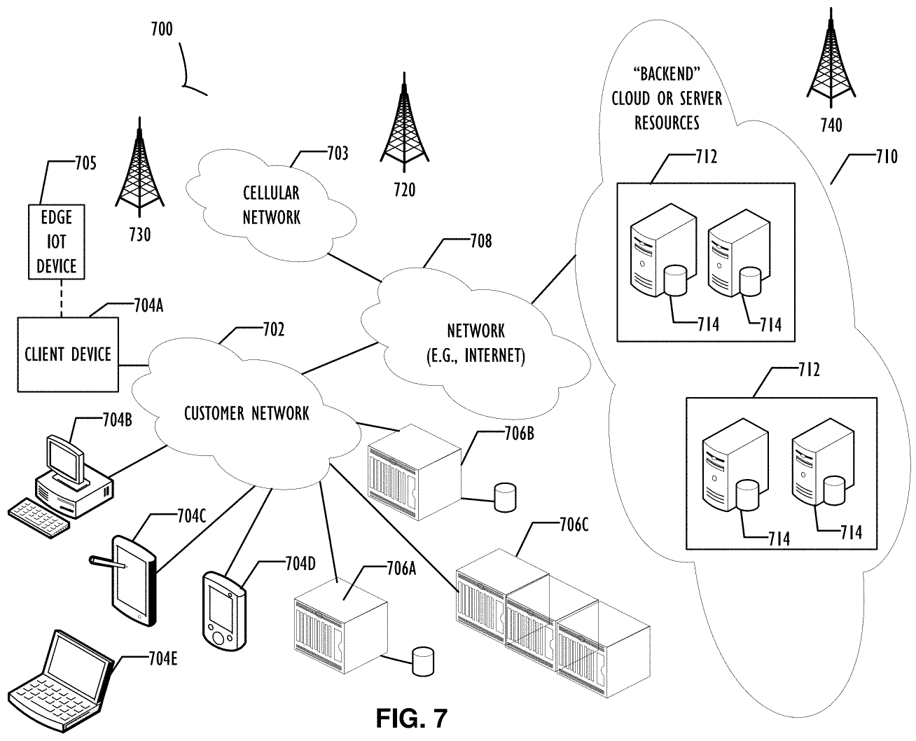

FIG. 7 represents a computer network infrastructure that may be used to implement all or part of the disclosed infrastructure program management platforms, according to one or more disclosed examples. Network infrastructure 700 includes a set of networks where implementations of the present disclosure may operate. Network infrastructure 700 comprises a customer network 702, network 708, cellular network 703, and a cloud service provider network 710. Each of these different networks may include one or more constituent elements of an infrastructure program management platform according to the concepts of this disclosure. In one implementation, the customer network 702 may be a local private network, such as local area network (LAN) that includes a variety of network devices that include, but are not limited to switches, servers, and routers.

Each of these networks can contain wired or wireless programmable devices and operate using any number of network protocols (e.g., TCP/IP) and connection technologies (e.g., WiFi® networks, or Bluetooth®. In another implementation, customer network 702 represents an enterprise network that could include or be communicatively coupled to one or more local area networks (LANs), virtual networks, data centers and/or other remote networks (e.g., 708, 710). In the context of the present disclosure, customer network 702 may include one or more high-availability data stores (e.g., master data repository 200), switches, or network devices using methods and techniques such as those described above.

As shown in FIG. 7, customer network 702 may be connected to one or more client devices 704A-E and allow the client devices 704A-E to communicate with each other and/or with cloud service provider network 710, via network 708 (e.g., Internet). Client devices 704A-E may be computing systems such as desktop computer 704B, tablet computer 704C, mobile phone 704D, laptop computer (shown as wireless) 704E, and/or other types of computing systems generically shown as client device 704A. However, while it is true that client devices may often run client applications, there are situations where a client device will execute the server side of a client-server application such that the client device communicates with a server device (e.g., executing the client application) to request remote execution on behalf of the client device. That is, the client device may execute a server application portion with the server device executing the client application portion for a given client-server application architecture. In general, the client portion of an application is the portion that requests some work and receives the results of the work, with the server portion receiving the request for work, performing that work, and providing the results.

Network infrastructure 700 may also include other types of devices generally referred to as Internet of Things (loT) (e.g., edge IOT device 705) that may be configured to send and receive information via a network to access cloud computing services or interact with a remote web browser application (e.g., to receive configuration information).

FIG. 7 also illustrates that customer network 702 includes local compute resources 706A-C that may include a server, access point, router, or other device configured to provide for local computational resources and/or facilitate communication amongst networks and devices. For example, local computing resources 706A-C may be one or more physical local hardware devices to support a master data repository as outlined above. Local compute resources 706A-C may also facilitate communication between other external applications, data sources (e.g., 707A and 707B), and services, and customer network 702.

Network infrastructure 700 also includes cellular network 703 for use with mobile communication devices. Mobile cellular networks support mobile phones and many other types of mobile devices such as laptops etc. Mobile devices in network infrastructure 700 are illustrated as mobile phone 704D, laptop computer 704E, and tablet computer 704C. A mobile device such as mobile phone 704D may interact with one or more mobile provider networks as the mobile device moves, typically interacting with a plurality of mobile network towers 720, 730, and 740 for connecting to the cellular network 703.

FIG. 7 illustrates that customer network 702 is coupled to a network 708. Network 708 may include one or more computing networks available today, such as other LANs, wide area networks (WAN), the Internet, and/or other remote networks, in order to transfer data between client devices 704A-D and cloud service provider network 710. Each of the computing networks within network 708 may contain wired and/or wireless programmable devices that operate in the electrical and/or optical domain.

In FIG. 7, cloud service provider network 710 is illustrated as a remote network (e.g., a cloud network) that is able to communicate with client devices 704A-E via customer network 702 and network 708. The cloud service provider network 710 acts as a platform that provides additional computing resources to the client devices 704A-E and/or customer network 702. In one implementation, cloud service provider network 710 includes one or more data centers 712 with one or more server instances 714. Cloud service provider network 710 may also include one or more frames or clusters (and cluster groups) representing a scalable compute resource that may benefit from the techniques of this disclosure. Also, cloud service providers typically require near perfect uptime availability and may use the disclosed techniques, methods, and systems to provide that level of service.

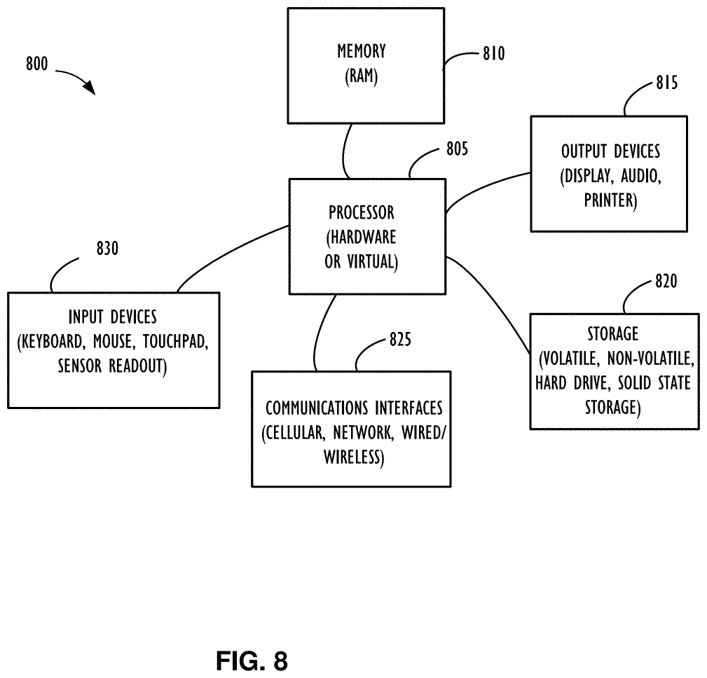

FIG. 8 illustrates a computing device 800 that may be used to implement or be used with the functions, modules, processing platforms, execution platforms, communication devices, and other methods and processes of this disclosure. For example, computing device 800 illustrated in FIG. 8 could represent a client device or a physical server device and include either hardware or virtual processor(s) depending on the level of abstraction of the computing device. In some instances (without abstraction), computing device 800 and its elements, as shown in FIG. 8, each relate to physical hardware. Alternatively, in some instances one, more, or all of the elements could be implemented using emulators or virtual machines as levels of abstraction. In any case, no matter how many levels of abstraction away from the physical hardware, computing device 800 at its lowest level may be implemented on physical hardware.

As also shown in FIG. 8, computing device 800 may include one or more input devices 830, such as a keyboard, mouse, touchpad, or sensor readout (e.g., biometric scanner) and one or more output devices 815, such as displays, speakers for audio, or printers. Some devices may be configured as input/output devices also (e.g., a network interface or touchscreen display).

Computing device 800 may also include communications interfaces 825, such as a network communication unit that could include a wired communication component and/or a wireless communications component, which may be communicatively coupled to processor 805. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi, cellular, and/or other communication methods.

As illustrated in FIG. 8, computing device 800 includes a processing element such as processor 805 that contains one or more hardware processors, where each hardware processor may have a single or multiple processor cores. In one implementation, the processor 805 may include at least one shared cache that stores data (e.g., computing instructions) that are utilized by one or more other components of processor 805. For example, the shared cache may be a locally cached data stored in a memory for faster access by components of the processing elements that make up processor 805. In one or more implementations, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 8, the processing elements that make up processor 805 may also include one or more of other types of hardware processing components, such as graphics processing units (GPU), application specific integrated circuits (ASICs), field-programmable gate arrays (FPGAs), and/or digital signal processors (DSPs).

FIG. 8 illustrates that memory 810 may be operatively and communicatively coupled to processor 805. Memory 810 may be a non-transitory medium configured to store various types of data. For example, memory 810 may include one or more storage devices 820 that comprise a non-volatile storage device and/or volatile memory. Volatile memory, such as random-access memory (RAM), can be any suitable non-permanent storage device. The non-volatile storage devices 820 can include one or more disk drives, optical drives, solid-state drives (SSDs), tap drives, flash memory, read only memory (ROM), and/or any other type of memory designed to maintain data for a duration of time after a power loss or shut down operation. In certain instances, the non-volatile storage devices 820 may be used to store overflow data if allocated RAM is not large enough to hold the working data. The non-volatile storage devices 820 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 805. In one implementation, the compiling process of the software program may transform program code written in a programming language to another computer language such that the processor 805 is able to execute the programming code. For example, the compiling process of the software program may generate an executable program that provides encoded instructions (e.g., machine code instructions) for processor 805 to accomplish specific, non-generic, particular computing functions.

After the compiling process, the encoded instructions may then be loaded as computer executable instructions or process steps to processor 805 from storage device 820, from memory 810, and/or embedded within processor 805 (e.g., via a cache or on-board ROM). Processor 805 may be configured to execute the stored instructions or process steps in order to perform instructions or process steps to transform the computing device into a non-generic, particular, specially programmed machine or apparatus. Stored data, e.g., data stored by a storage device 820, may be accessed by processor 805 during the execution of computer executable instructions or process steps to instruct one or more components within the computing device 800.

A user interface (e.g., output devices 815 and input devices 830) can include a display, positional input device (such as a mouse, touchpad, touchscreen, or the like), keyboard, or other forms of user input and output devices. The user interface components may be communicatively coupled to processor 805. When the output device is or includes a display, the display can be implemented in various ways, including by a liquid crystal display (LCD) or a cathode-ray tube (CRT) or light emitting diode (LED) display, such as an organic light emitting diode (OLED) display. Persons of ordinary skill in the art are aware that the computing device 800 may comprise other components well known in the art, such as sensors, powers sources, and/or analog-to-digital converters, not explicitly shown in FIG. 8.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A computer-implemented method of managing logistics and assets associated with an infrastructure program, the method comprising:
populating a master data repository maintained in a data server with infrastructure data identifying assets associated with said infrastructure project and attributes of said assets including asset dependencies;
populating said master data repository with release and requirement data reflecting release and requirement metrics established for said infrastructure program;
populating said master data repository with questionnaire data reflecting asset configuration attributes for said assets associated with said infrastructure program; and
updating said master data repository to reflect changes in either said assets associated with said infrastructure project—said attributes of said assets associated with said infrastructure program, or said release and requirement metrics.

2. A computer-implemented method in accordance with claim 1, wherein said infrastructure program comprises a migration of said infrastructure assets at a data center of an enterprise.

3. A computer-implemented method in accordance with claim 1, further comprising:
limiting user access to data in said repository through an access control list.

4. A computer-implemented method in accordance with claim 1, further comprising:
providing historical repository of weekly program status reporting in said repository; and
providing user access to data in said master data repository via a user interface.

5. A computer-implemented method in accordance with claim 1, wherein populating a master data repository maintained in a data server with infrastructure data identifying assets associated with said infrastructure project and attributes of said assets comprises using asset discovery tools.

6. A computer-implemented method in accordance with claim 1, wherein said step of populating a master data repository maintained in a data server with infrastructure data identifying assets associated with said infrastructure project and attributes of said assets comprises using configuration management database tools.

7. A computer-implemented method in accordance with claim 1, wherein providing access to data in said master data repository via a user interface includes using a software resource to access and process data in said master data repository.

8. A computer-implemented method in accordance with claim 1, wherein providing user access to said master repository of data comprises providing an interactive graphical user interface to a user.

9. A computer device, comprising:
at least one hardware processor;
at least one memory storage device for storing a master repository of data comprising infrastructure asset and asset attribute information including asset dependency information;
said computer device being operable to populate said master repository of data with asset and asset attribute information, said asset and asset attribute information including mapping of dependencies between assets associated with said infrastructure program; and
said computer device being further operable to populate said master repository of data with requirement and release data specified for said infrastructure program;
said master repository of data including mapping of dependencies between said assets associated with said infrastructure program and of dependencies between said assets associated with said infrastructure program and requirement and release data and questionnaire data obtained from users.

10. A computer device in accordance with claim 9, wherein said infrastructure program comprises a migration of a data center of an enterprise.

11. A computer device in accordance with claim 9, wherein said computer device is operable to obtain said infrastructure asset and asset attribute information from a configuration management database tool.

12. A computer device in accordance with claim 11, wherein said computer device is operable to obtain said infrastructure asset and asset attribute information from an asset discovery tool.

13. A computer device in accordance with claim 9, wherein said computer device is further operable to provide user access to said master repository of data.

14. A computer device in accordance with claim 13, wherein said computer device is further operable to limit user access to said master repository of data by maintaining an access control list.

15. A computer device in accordance with claim 13, wherein said computer device is further operable to restrict user access to said master repository of data by maintaining a list of authorized users.

16. A non-transitory computer-readable medium comprising computer-executable instructions stored thereon that when executed by one or more hardware processors cause the one or more hardware processors to:
populate a master data repository maintained in a data server with infrastructure data identifying assets associated with said infrastructure project and attributes of said assets including asset dependencies;
populate said master data repository with release and requirement data reflecting release and requirement metrics established for said infrastructure program;
update said master data repository to reflect changes in either said infrastructure assets, said attributes of infrastructure assets, or said release and requirement metrics; and
provide access to data in said master data repository via a user interface;
wherein said infrastructure program comprises a migration a data center of an enterprise.

17. A non-transitory computer-readable medium in accordance with claim 16 wherein said computer-executable instructions stored thereon when executed by one or more hardware processors further cause the one or more hardware processors to populate said master data repository with data reflecting questionnaire data obtained from users.

18. A non-transitory computer-readable medium in accordance with claim 16, wherein said infrastructure data identifying assets associated with said infrastructure project and attributes of said assets is provided from a configuration management development tool.

19. A non-transitory computer-readable medium in accordance with claim 18, wherein said infrastructure data identifying assets associated with said infrastructure project and attributes of said assets is provided from an asset discovery tool.

20. A non-transitory computer-readable medium in accordance with claim 16, wherein said computer-executable instructions stored thereon when executed by one or more hardware processors further cause the one or more hardware processors to maintain an access list for identifying users authorized to access said master data repository.
